(19) United States
(12) Patent Application Publication
(10) Pub. No.: US 2010/0043219 A1
(43) Pub. Date: Feb. 25, 2010

(54) DAUGHTER CARD EXTRACTOR TOOL

(75) Inventor: Hinh NGUYEN, Escondido, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/197,543

(22) Filed: Aug. 25, 2008

(51) Int. Cl. H01R 43/22; B23P 19/04

(52) U.S. Cl. 29/764; 254/131; 29/426.5

(57) ABSTRACT

A daughter card extractor tool is disclosed and may include a handle that defines a proximal end and a distal end. Further, the daughter card extractor tool may include a daughter card engagement assembly that may extend from the distal end of the handle. The daughter card extractor tool is movable between a first position in which the daughter card engagement assembly is partially engaged with a daughter card and the daughter card is engaged with a motherboard, a second position in which the daughter card extractor tool is fully engaged with the daughter card and the daughter card remains engaged with the motherboard, and a third position in which the daughter card engagement assembly remains fully engaged with the daughter card and the daughter card is at least partially disengaged from the motherboard.

### FIELD

The present invention generally relates to computer devices, and more particularly, to tools for extracting daughter cards from motherboards within computer devices.

### DESCRIPTION OF THE RELATED ART

A typical computer device, e.g., a desktop computer, a laptop computer, a server, or any other electronic device that includes a processor, etc. may include a motherboard. One or more daughter cards may be engaged with the motherboard. The daughter card may include a plurality of connectors that may engage correspondingly sized and shaped connectors on the motherboard. Removing the daughter card from the motherboard may be difficult and may result in damage to the motherboard, the daughter card, or both.

Accordingly, there exists a need for a tool to assist in disengaging a daughter card from a motherboard.

### SUMMARY OF THE DISCLOSURE

A daughter card extractor tool is disclosed and may include a handle that defines a proximal end and a distal end. Further, the daughter card extractor tool may include a daughter card engagement assembly that may extend from the distal end of the handle. The daughter card extractor tool is movable among a first position in which the daughter card engagement assembly is partially engaged with the daughter card while the daughter card is engaged with a motherboard, a second position in which the daughter card engagement assembly is fully engaged with the daughter card while the daughter card remains engaged with the motherboard, and a third position in which the daughter card engagement assembly remains fully engaged with the daughter card while the daughter card is at least partially disengaged from the motherboard.

In still another aspect, a kit is disclosed and may include a server that has a motherboard. The kit may also include a daughter card that is configured to be installed within the motherboard. Further, the kit may include a daughter card extractor tool that is configured to engage the daughter card when the daughter card is installed in the motherboard and to provide an extraction force on a lower surface of the daughter card to disengage the daughter card from the motherboard.

In yet another aspect, a kit is disclosed and may include a daughter card that may be configured to be installed within a motherboard. The kit may also include a daughter card extractor tool that is configured to engage the daughter card when daughter card is installed in the motherboard and to provide an extraction force on a lower surface of the daughter card to disengage the daughter card from the motherboard.

In another aspect, a daughter card extractor tool is disclosed and may include a means for handling and a daughter card means for engagement extending from the handling means. In this aspect, the daughter card extractor tool is movable among a first position in which the daughter card engagement means is partially engaged with a daughter card while the daughter card is engaged with a motherboard, a second position in which the daughter card engagement means is fully engaged with the daughter card while the daughter card remains engaged with the motherboard, and a third position in which the daughter card engagement means remains fully engaged with the daughter card while the daughter card is at least partially disengaged from the motherboard.

In still another aspect, a method of extracting a daughter card from a mother board within an electronic device is disclosed. The method may include engaging a daughter card extractor tool with the daughter card and moving the daughter card extractor tool from a first position in which the daughter card engagement assembly is partially engaged with a daughter card while the daughter card is engaged with a motherboard to a second position in which the daughter card engagement assembly is fully engaged with the daughter card while the daughter card remains engaged with the motherboard. Further, the method may include moving the daughter card extractor tool from the second position to a third position in which the daughter card engagement assembly remains fully engaged with the daughter card while the daughter card is at least partially disengaged from the motherboard.

### BRIEF DESCRIPTION OF THE DRAWINGS

In the figures, like reference numerals refer to like parts throughout the various views unless otherwise indicated.

FIG. 1 is a plan view of a first daughter card extractor tool;

FIG. 2 is a plan view of the first daughter card extractor tool partially engaged with a daughter card;

FIG. 3 is a detailed view of the first daughter card extractor tool taken at circle 3 within FIG. 2;

FIG. 4 is a perspective view of the first daughter card extractor tool fully engaged with the daughter card;

FIG. 5 is a plan view of the first daughter card extractor tool fully engaged with the daughter card;

FIG. 6 is a detailed view of the first daughter card extractor tool taken at circle 6 within FIG. 5;

FIG. 7 is a detailed view of the first daughter card extractor tool taken at circle 7 within FIG. 5;

FIG. 8 is a perspective view of the first daughter card extractor tool engaged with the daughter card installed in a motherboard;

FIG. 9 is another perspective view of the first daughter card extractor tool engaged with a daughter card installed in a motherboard;

FIG. 10 is a perspective view of a second daughter card extractor tool;

FIG. 11 is a cross-section view of the second daughter card taken along line 11-11 within FIG. 10;

FIG. 12 is a perspective view of the second daughter card extractor tool fully engaged with a daughter card;

FIG. 13 is a detailed perspective view of the second daughter card extractor tool taken at ellipse 13 within FIG. 12;

FIG. 14 is a perspective view of the second daughter card engaged with the daughter card installed in a motherboard; and

FIG. 15 is another perspective view of the second daughter card engaged with the daughter card installed in a motherboard.

### DETAILED DESCRIPTION

The word “exemplary” is used herein to mean “serving as an example, instance, or illustration.” Any aspect described herein as “exemplary” is not necessarily to be construed as preferred or advantageous over other aspects.

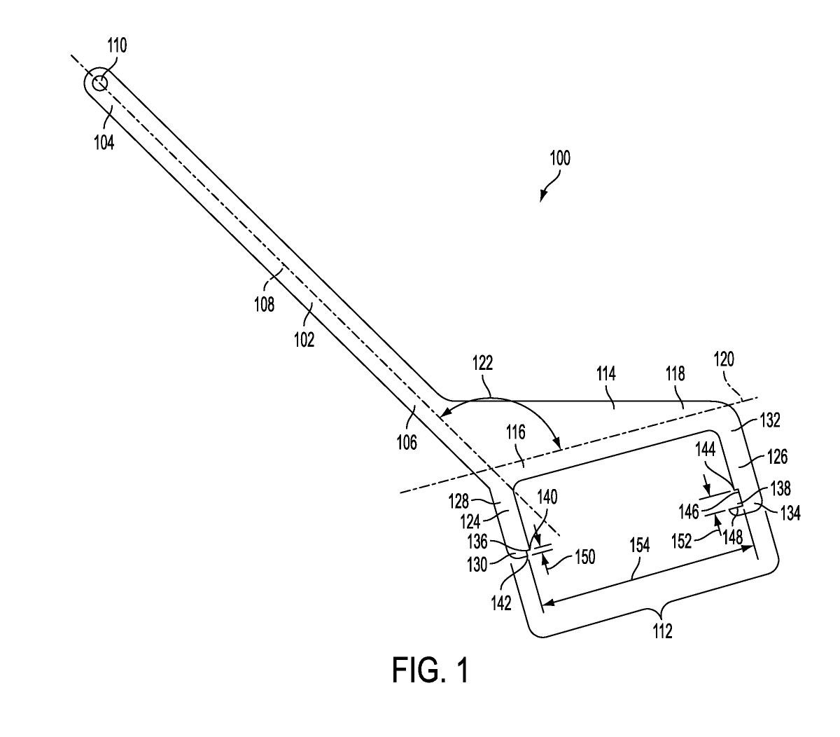

Referring to FIG. 1, a first aspect of a daughter card extractor tool is shown and is generally designated 100. As illustrated, the daughter card extractor tool 100 includes a handle 102 that may include a proximal end 104 and a distal end 106. Further, the handle 102 of the daughter card extractor tool 100 may define an axis 108. The proximal end 104 of the handle 102 may be formed with a hole 110. The hole 110 may be sized and shaped to allow a cable (not shown) to be passed through the handle 102 of the daughter card extractor tool 100. The cable (not shown) may act as a tether and may prevent the daughter card extractor tool 100 from falling into a motherboard, described below, and causing damage to the motherboard while the daughter card extractor tool 100 is being used to extract a daughter card from the motherboard, as described in detail below.

FIG. 1 indicates that the daughter card extractor tool 100 may further include a daughter card engagement assembly 112 that may extend from, or be integrally formed with, the distal end 106 of the handle 102 of the daughter card extractor tool 100. As shown, the daughter card engagement assembly 112 of the daughter card extractor tool 100 may include a lateral arm 114 that may extend from the distal end 106 of the handle 102. The lateral arm 114 may include a proximal end 116 and a distal end 118. Further, the lateral arm 114 may define an axis 120. The axis 120 of the lateral arm 114 that may establish an angle 122 with respect to the axis 108 of the handle 102 of the daughter card extractor tool 100. In a particular aspect, the angle 114 that the axis 120 of the lateral arm 114 forms with respect to the axis 108 of the handle 102 may be in a range of one hundred ten degrees to one hundred thirty degrees (110° and 130°).

Referring still to FIG. 1, the daughter card engagement assembly 112 may include a first daughter card engagement arm 124 that extends from the lateral arm 114. The first daughter card engagement arm 124 may extend from the lateral arm 114 substantially perpendicular to the axis 120 of the lateral arm 114. Further, as indicated in FIG. 1, the daughter card engagement assembly 112 may include a second daughter card engagement arm 126 that extends from the lateral arm 114. The second daughter card engagement arm 126 may also extend from the lateral arm 114 substantially perpendicular to the axis 120 of the lateral arm 114 in the same direction as the first daughter card engagement arm 124.

As illustrated in FIG. 1, the first daughter card engagement arm 124 may include a proximal end 128 and a distal end 130. The second daughter card engagement arm 126 may also include a proximal end 132 and a distal end 134. The distal end 130 of the first daughter card engagement arm 124 may be formed with a notch 136. Moreover, the distal end 134 of the second daughter card engagement arm 126 may be formed with a hook 138.

FIG. 1 indicates that the notch 136 formed in the distal end 130 of the first daughter card engagement arm 124 may include an upper face 140 and a side face 142. The upper face 140 of the notch 136 may be substantially parallel to the axis 120 of the lateral arm 114. The side face 142 of the notch 136 may be substantially perpendicular to the axis 120 of the lateral arm 114 and substantially perpendicular to the upper face 140 of the notch 136.

The hook 138 formed in the distal end 134 of the second daughter card engagement arm 126 may include an upper face 144, a side face 146, and a lower face 148. The upper face 144 of the hook 138 may be substantially parallel to the axis 120 of the lateral arm 114. The side face 146 of the hook 138 may be substantially perpendicular to the axis 120 of the lateral arm 114 and substantially perpendicular to the upper face 144 of the hook 138. Moreover, the lower face 148 of the hook 138 may be substantially parallel to the axis 120 of the lateral arm 114 and substantially parallel to the upper face 144 of the hook 138.

As depicted in FIG. 1, the notch 136 formed in the distal end 130 of the first daughter card engagement arm 124 may have a depth 150. It is to be understood that the depth 150 of the notch 136 is the distance from the upper face 140 of the notch 136 to the far distal end 130 of the first daughter card engagement arm 124. The hook 138 formed in the distal end 134 of the second daughter card engagement arm 126 may also have a depth 152. It is to be understood that the depth 152 of the hook 138 is the distance between the upper face 144 of the hook 138 and the lower face 148 of the hook 138.

The depth 150 of the notch 136 is such that the notch 136 may fit over the edge of a daughter card, described below. Further, the depth 152 of the hook 138 is such that the hook 138 may fit around another edge of the daughter card.

FIG. 1 further shows that that the daughter card engagement assembly 112 of the daughter card engagement tool 100 may have a width 154. It is to be understood that the width 154 of the daughter card engagement assembly 112 is the distance between the side face 142 of the notch 136 formed in the first daughter card engagement arm 124 and the side face 146 of the hook 138 formed in the second daughter card engagement arm 126.

The width 154 of the daughter card engagement assembly 112 is such that the daughter card engagement assembly 112 may fit over a daughter card, described below, and allow the notch 136 and the hook 138 to engage the daughter card as described herein.

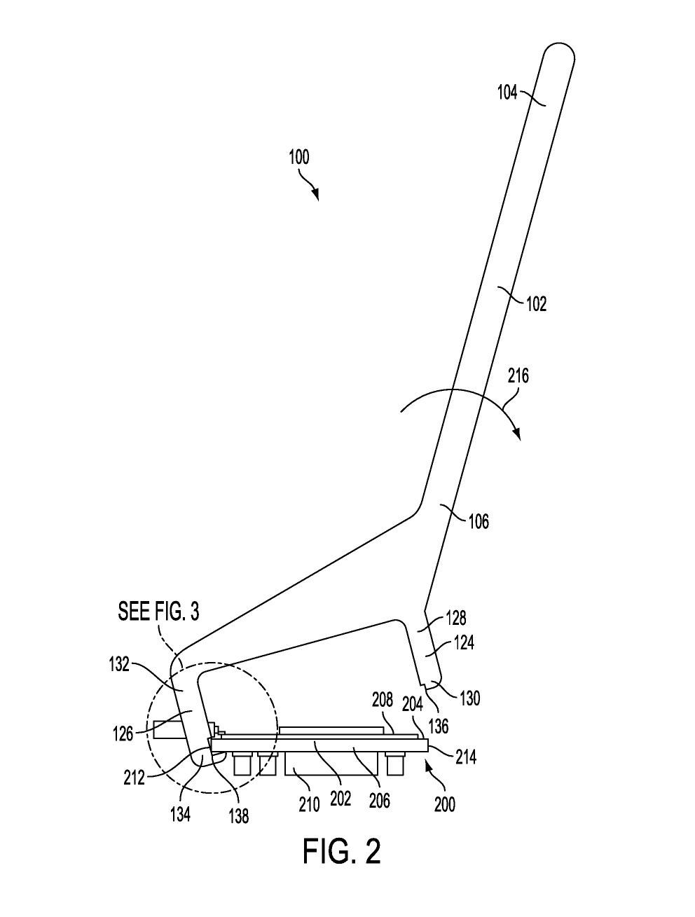

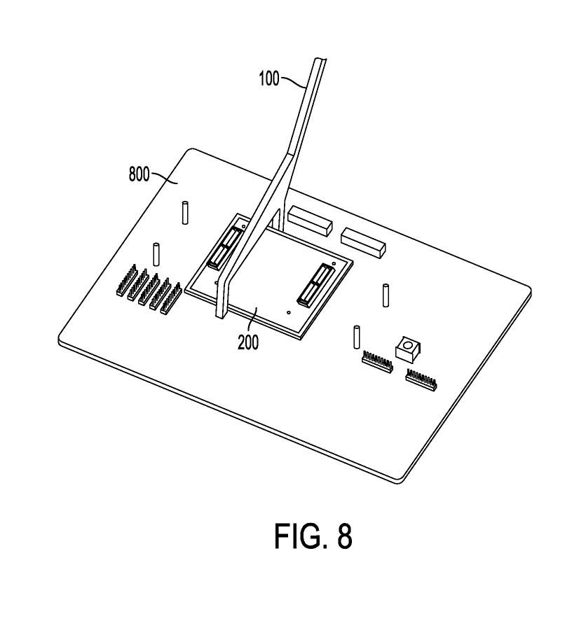

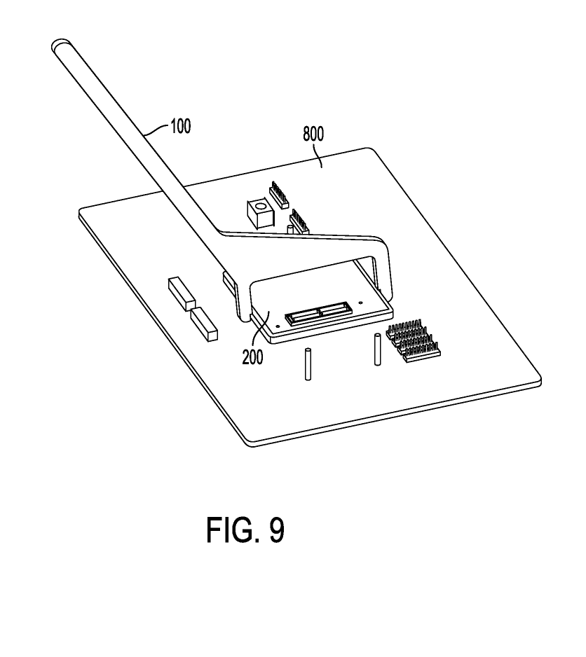

Referring now to FIG. 2, the daughter card extractor tool 100 is shown partially engaged with a daughter card 200. In a particular aspect, the daughter card 200 may provide network connectivity, e.g., to a cellular device, a mobile device, or a communication network. As shown, the daughter card 200 includes a substrate 202. The substrate 202 may include an upper surface 204 and a lower surface 206. A circuit board 208 may be disposed on, or over, the upper surface 204 of the substrate 202. The daughter card 200 may include at least one connector bank 210 that may extend beyond the lower surface 206 of the substrate 202. In a particular aspect, the daughter card 200 may include as many as five or six connector banks 210. Each connector bank 210 may be a one hundred twenty pin connector bank. The connector bank 210 on the daughter card 200 is substantially sized and shaped to fit into, or around, a correspondingly substantially sized and shaped connector bank (not shown) on a motherboard 800, shown in FIG. 8 and FIG. 9. FIG. 2 indicates that the daughter card 200 may define a leading edge 212 and a trailing edge 214.

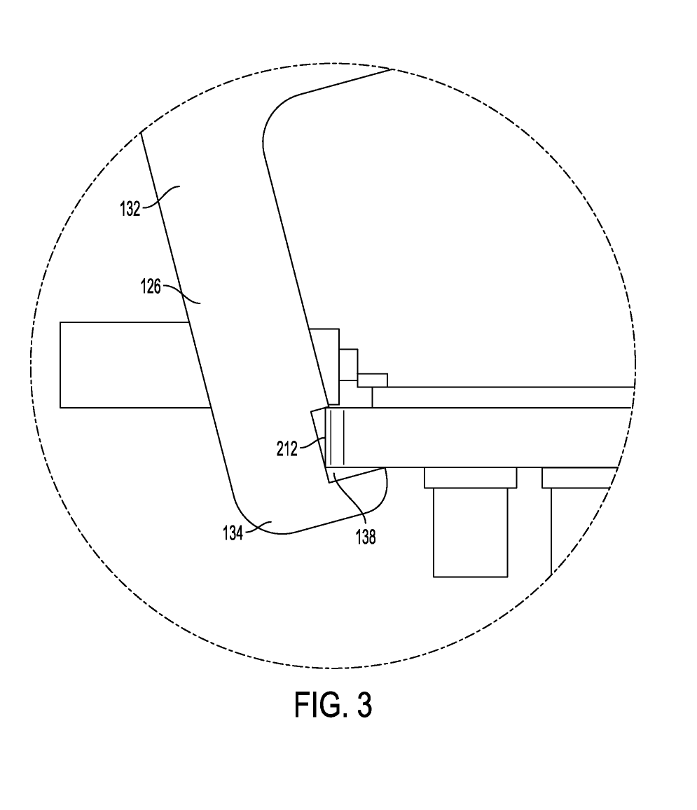

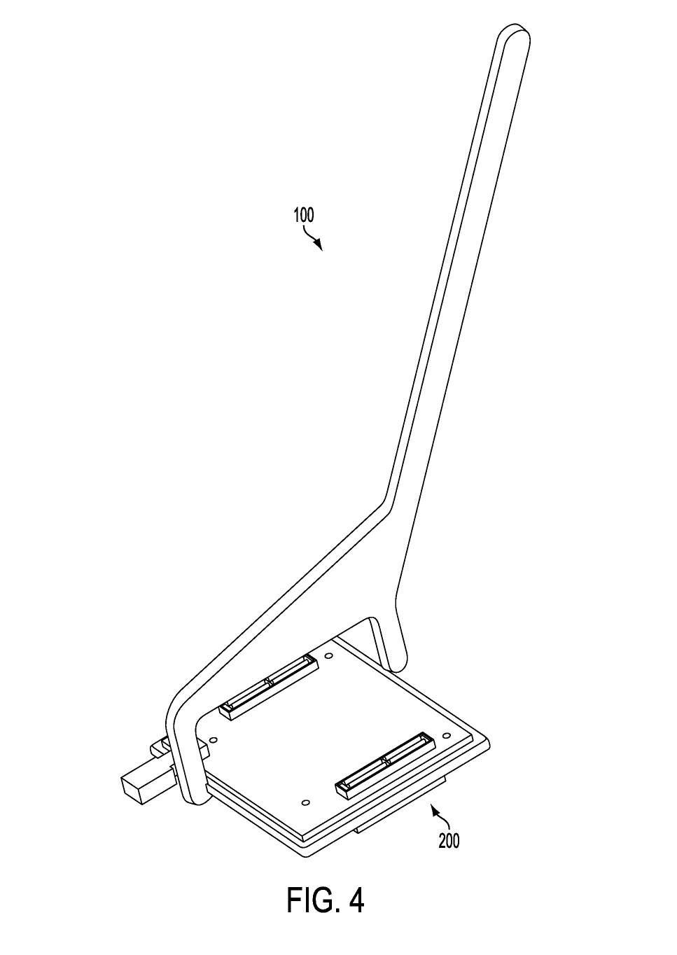

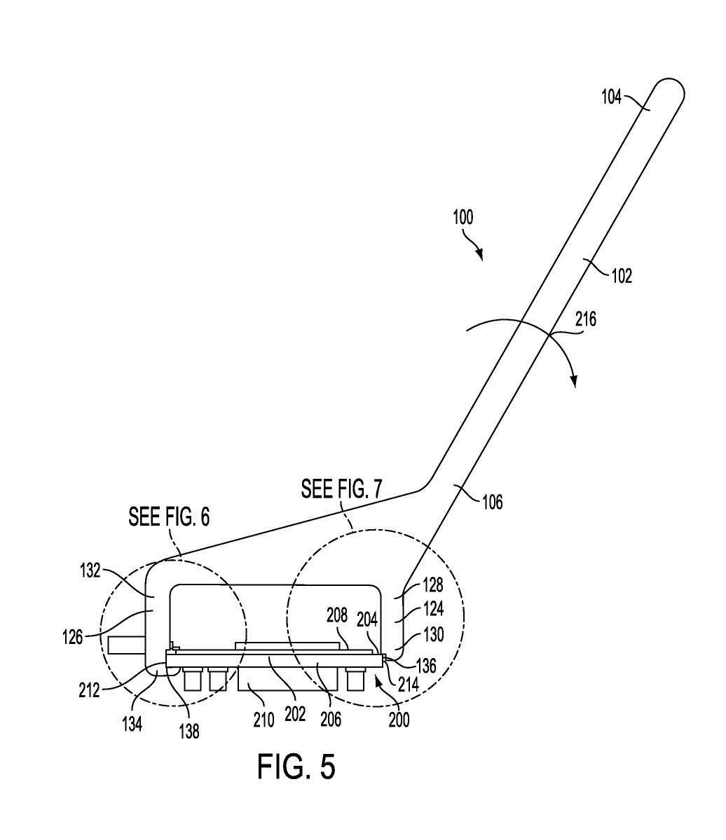

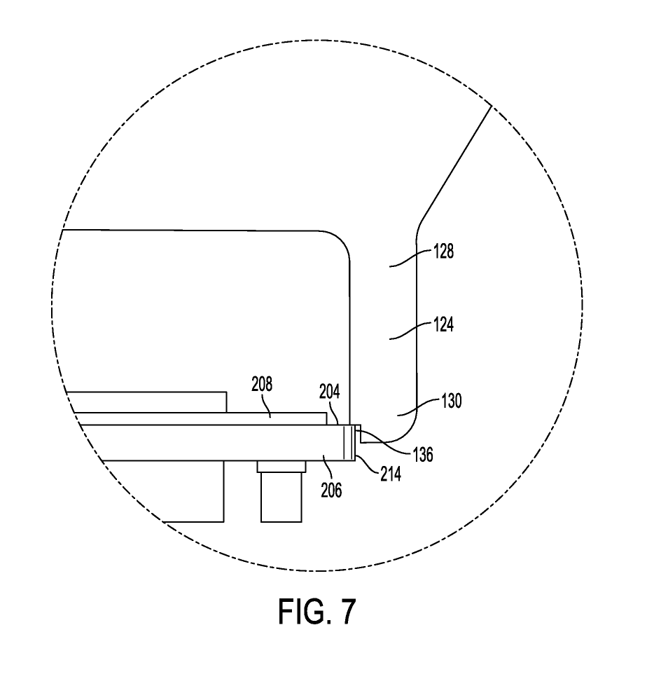

As indicated in FIG. 2 and FIG. 3, during use of the daughter card extractor tool 100, the hook 138 formed in the distal end 134 of the second daughter card engagement arm 126 may be moved over the leading edge 208 of the daughter card 200 such that the upper face 144 of the hook 138 rests on, or otherwise engages, the upper surface 204 of the substrate 202 of the daughter card 200. Thereafter, the daughter card extractor tool 100 may be rotated clockwise in FIG. 2, as indicated by arc 216, so that the notch 136 formed in the distal end 130 of the first daughter card engagement arm 124 moves downward toward the upper surface 204 of the substrate 202 until the upper face 140 of the notch 136 rests against, or otherwise engages, the upper surface 204 of the substrate 202, as shown in FIG. 4, FIG. 5, and FIG. 7.

As the daughter card extractor tool 100 continues to rotate in the direction indicated by arc 216, the upper face 144 of the hook 138 formed in the distal end 134 of the second daughter card engagement arm 126 may disengage from the upper surface 204 of the substrate 202 and the lower face 148 of the hook 138 formed in the distal end 134 of the second daughter card engagement arm 126 may engage the lower surface 206 of the substrate 202. The upper face 140 of the notch 136 formed in the distal end 130 of the first daughter card engagement arm 124 may remain in contact with the upper surface 204 of the substrate 202.

Further, the interface between the upper face 140 of the notch 136 and the area of contact on the upper surface 204 of the substrate 202 may act as a fulcrum and the daughter card extractor tool 100 may rotate about the fulcrum. As the daughter card extractor tool 100 continues to rotate in the direction indicated by arc 216, the lower face 148 of the hook 138 may provide an extraction force 216 on the lower surface 206 of the substrate 202. Once the extraction force 216 overcomes the engagement force between the connector bank 210 on the daughter card 200 and the connector bank on the motherboard 800, the daughter card 200 may begin to disengage from the motherboard 800. Once the daughter card 200 is sufficiently disengaged from the motherboard 800, a user may reach in with his or her thumb and forefinger to safely remove and retrieve the daughter card 200 from the motherboard 800.

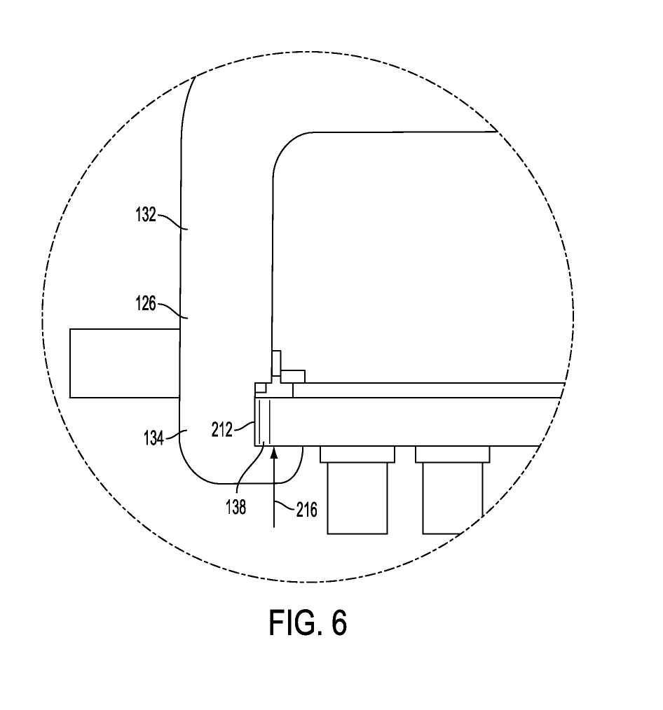

As discussed above, FIG. 3 is a detailed view of the the partial engagement of the daughter card extractor tool 100 with the daughter card 200 taken at circle 3 in FIG. 3. FIG. 4 and FIG. 5 illustrates the daughter card extractor tool 100 fully engaged with the daughter card 200. FIG. 6 is a first detailed view of the full engagement of the daughter card extractor tool 100 with the daughter card 200 taken at circle 6 in FIG. 5. FIG. 7 is a second detailed view of the full engagement of the daughter card extractor tool 100 with the daughter card 200 taken at circle 7 in FIG. 5. FIG. 8 and FIG. 9 are perspective views of the daughter card extractor tool 100 fully engaged with the daughter card 200 while the daughter card 200 is installed in the motherboard 800.

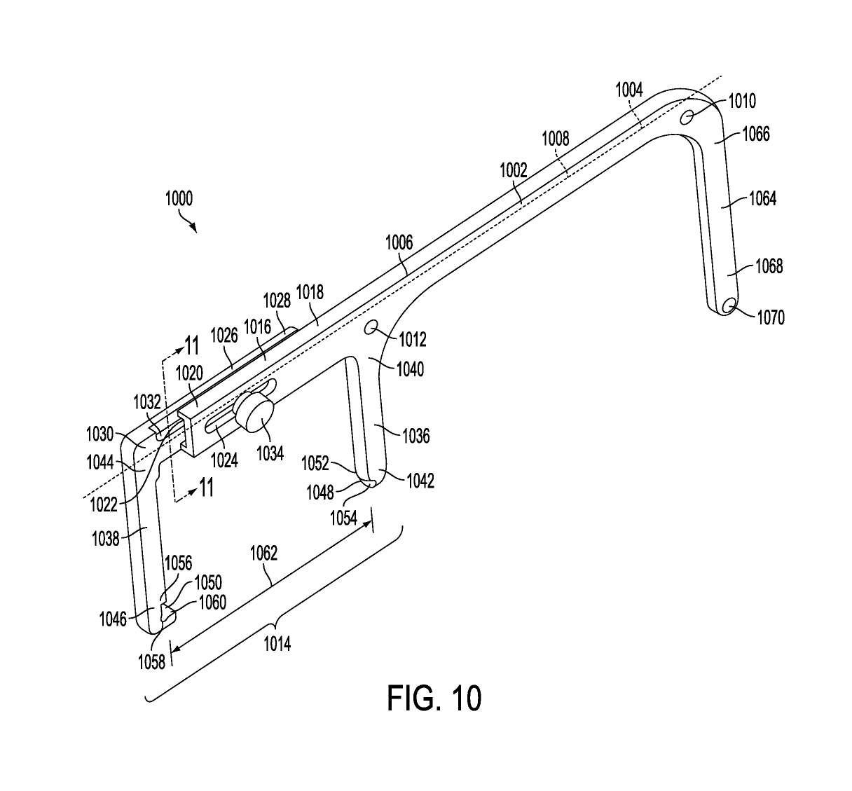

Referring to FIG. 10, a second aspect of a daughter card extractor tool is shown and is generally designated 1000. As illustrated, the daughter card extractor tool 1000 includes a handle 1002 that may include a proximal end 1004 and a distal end 1006. Further, the handle 1002 of the daughter card extractor tool 1000 may define an axis 1008. The proximal end 1004 of the handle 1002 may be formed with a hole 1010. Further, the distal end 1006 of the handle 1002 may be formed with a hole 1012. The holes 1010, 1012 in the handle 1002 may facilitate manufacturing of the daughter card extractor tool.

FIG. 10 indicates that the daughter card extractor tool 1000 may further include a daughter card engagement assembly 1014 that may extend from the distal end 1006 of the handle 1002 of the daughter card extractor tool 1000. As shown, the daughter card engagement assembly 1014 of the daughter card extractor tool 1000 may include a first portion 1016 that may extend from the distal end 1006 of the handle 1002. The first portion 1016 may include a proximal end 1018 and a distal end 1020. Further, the first portion 1014 may extend along the axis 1008 that is defined by the handle 1002. The first portion 1016 may also be formed with a groove 1022 that extends substantially along the length of the first portion 1016 from the distal end 1020 of the first portion 1016 to the proximal end 1018 of the first portion 1016. Further, the first portion 1016 may be formed with a slot 1024 that extends laterally through the first portion 1016 along the first portion 1016 near the distal end 1020 of the first portion 1016.

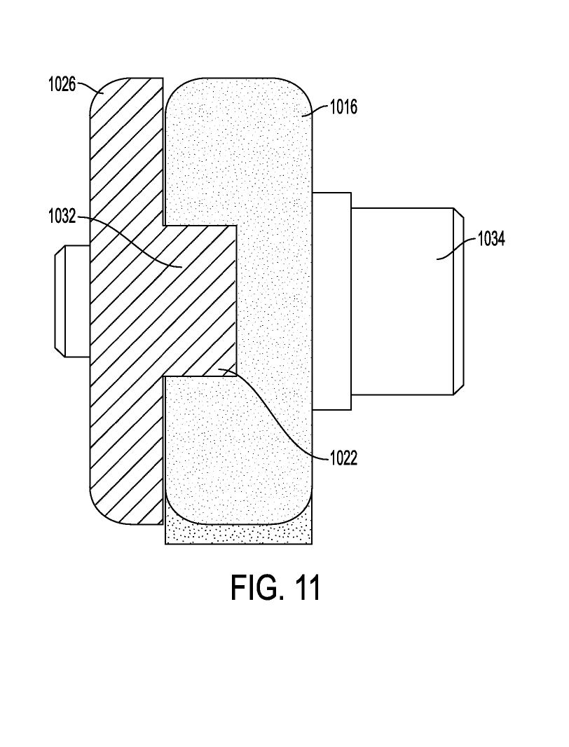

As depicted in FIG. 10, the daughter card engagement assembly 1014 of the daughter card extractor tool 1000 may also include a second portion 1026 that extends along the axis 1008 defined by the handle 1002. The second portion 1026 may include a proximal end 1028 and a distal end 1030. Also, the second portion 1026 may be formed with a tongue 1032 substantially along the length of the second portion 1026 from the proximal end 1026 of the second portion 1026 to the distal end 1030 of the second portion 1026. The tongue 1032 formed on second portion 1026 of the daughter card engagement assembly 1014 is sized and shaped to fit into the groove 1022 formed in the first portion 1016 of the daughter card engagement assembly 1014. More specifically, the tongue 1032 and groove 1022 arrangement may allow the second portion 1026 to slide into and out of the first portion 1016 in order to allow the daughter card engagement assembly 1014 to be adjusted, as described in detail below, so that the daughter card engagement tool 1000 may be used to extract daughter cards having varying sizes and shapes. The second portion 1026 may also include a lateral hole (not shown) formed therein. The lateral hole in the second portion 1026 may be formed with internal threads. Further, a thumb screw 1034, formed with corresponding external threads, may extend through the slot 1024 formed in the first portion 1016 and may engaged the lateral hole, as shown in FIG. 11. Accordingly, the thumb screw 1034 may be loosened to allow the second portion 1026 to slide relative to the first portion 1016. Also, the thumb screw 1034 may be substantially tightened to prevent the second portion 1026 from moving, or sliding, relative to the first portion 1016.

Referring still to FIG. 10, the daughter card engagement assembly 1014 may include a first daughter card engagement arm 1036 that extends from the first portion 1016. The first daughter card engagement arm 1036 may extend from the first portion 1016 substantially perpendicular to the first portion 1016. Further, as indicated in FIG. 10, the daughter card engagement assembly 1014 may include a second daughter card engagement arm 1038 that extends from the second portion 1026. The second daughter card engagement arm 1038 may also extend from the second portion 1026 substantially perpendicular to the second portion 1026 in the same direction as the first daughter card engagement arm 1036.

As illustrated in FIG. 10, the first daughter card engagement arm 1036 may include a proximal end 1040 and a distal end 1042. The second daughter card engagement arm 1038 may also include a proximal end 1044 and a distal end 1046. The distal end 1042 of the first daughter card engagement arm 1036 may be formed with a notch 1048. Moreover, the distal end 1046 of the second daughter card engagement arm 1038 may be formed with a hook 1050.

FIG. 10 indicates that the notch 1048 formed in the distal end 1042 of the first daughter card engagement arm 1036 may include an upper face 1052 and a side face 1054. The upper face 1052 of the notch 1048 may be substantially parallel to the axis 1008 of the handle 1002. The side face 1054 of the notch 1048 may be substantially perpendicular to the axis 1008 of the handle 1002 and substantially perpendicular to the upper face 1052 of the notch 1048.

The hook 1050 formed in the distal end 1046 of the second daughter card engagement arm 1038 may include an upper face 1056, a side face 1058, and a lower face 1060. The upper face 1056 of the hook 1050 may be substantially parallel to the axis 1008 of the handle 1008. The side face 1058 of the hook 1050 may be substantially perpendicular to the axis 1008 of the handle 1008 and substantially perpendicular to the upper face 1056 of the hook 1050. Moreover, the lower face 1060 of the hook 1050 may be substantially parallel to the axis 1008 of the handle 1008 and substantially parallel to the upper face 1056 of the hook 1050.

It is to be understood that the notch 1048 formed in the distal end 1042 of the first daughter card engagement arm 1036 may be configured similar to the notch 136 (FIG. 1) formed in the first daughter card extractor tool 100 (FIG. 1), described above. In other words, the notch 1048 may have a depth that is substantially similar to the depth 150 (FIG. 1) of the notch 136 (FIG. 1), described above. Further, it is to be understood that the hook 1050 formed in the distal end 1046 of the second daughter card engagement arm 1038 may be configured similar to the hook 138 (FIG. 1) formed in the first daughter card extractor tool 100 (FIG. 1), described above. In other words, the hook 1050 may have a depth that is substantially similar to the depth 152 (FIG. 1) of the hook 138 (FIG. 1), described above.

FIG. 10 further shows that that the daughter card engagement assembly 1014 of the daughter card engagement tool 1000 may have a width 1062. It is to be understood that the width 1062 of the daughter card engagement assembly 1014 is the distance between the side face 1054 of the notch 1048 formed in the first daughter card engagement arm 1036 and the side face 1058 of the hook 1050 formed in the second daughter card engagement arm 1038. Moreover, the width 1062 of the daughter card engagement assembly 1014 may be adjusted by loosening the thumb screw 1034 and sliding the second portion 1026 linearly along the axis 1008 relative to the first portion 1016. The second portion 1026 may be extended relative to the first portion 1016 in order to increase the width 1062. Conversely, the second portion 1026 may be retracted relative to the first portion 1016 in order to decrease the width 1062. Once the desired width 1062 is achieved, the thumb screw 1034 may be substantially tightened in order to prevent the second portion 1026 from sliding relative to the first portion 1016.

Still referring to FIG. 10, the daughter card extractor tool 1000 may include a motion limiting arm 1064 that may extend from the proximal end 1004 of the handle 1002. In a particular aspect, the motion limiting arm 1064 may extend from the handle 1002 in a direction that is substantially perpendicular to the axis 1008 of the handle 1002. Further, the motion limiting arm 1064 may extend in the same direction as the first daughter card engagement arm 1036 and the second daughter card engagement arm 1038.

As illustrated, the motion limiting arm 1064 may include a proximal end 1066 and a distal end 1068. The distal end 1068 of the motion limiting arm 1064 may be formed with a hole 1070. In a particular aspect, the hole 1070 formed in the distal end 1068 of the motion limiting arm 1064 may be sized and shaped to allow a cable (not shown) to be passed through the motion limiting arm 1064 of the daughter card extractor tool 1000. The cable (not shown) may act as a tether and may prevent the daughter card extractor tool 1000 from falling into a motherboard, described below, and causing damage to the motherboard while the daughter card extractor tool 1000 is being used to extract a daughter card from the motherboard, as described in detail below.

During use, describe below, the motion limiting arm 1064 may prevent the daughter card extractor tool 1000 from over-rotating and potentially, damaging a daughter card that is engaged with the daughter card extractor tool 1000. Such damage may include the daughter card peeling away from one or more connector banks, described below. In a particular aspect, the daughter card extractor tool 1000 may rotate over a range of zero degrees to minus five degrees (0°-5.0°). In another aspect, the daughter card extractor tool 1000 may rotate over a range of zero degrees to minus four and one-half degrees (0° to −4.5°). In yet another aspect, the daughter card extractor tool 1000 may rotate over a range of zero degrees to minus four degrees (0° to −4.0°). In still another aspect, the daughter card extractor tool 1000 may rotate over a range of zero degrees to minus three and one-half degrees (0° to −3.5°). In another aspect, the daughter card extractor tool 1000 may rotate over a range of zero degrees to minus three degrees (0° to −3°). Further, in another aspect, the daughter card extractor tool 1000 may rotate over a range of zero degrees to minus two and one-half degrees (0° to −2.5°). In yet another aspect, the daughter card extractor tool 1000 rotate over a range of zero degrees to minus two degrees (0° to −2.0°). In still another aspect, the daughter card extractor tool 1000 may rotate over a range of zero degrees to minus one and one-half degrees (0° to −1.5°). It is to be understood that at zero degrees (0°) the axis 1008 of the handle 1002 of the daughter card extractor tool 1000 is substantially parallel to an upper surface of the motherboard, described below.

In another aspect, the motion limiting arm 1064 may be made adjustable similar to the daughter card engagement assembly 1014 of the daughter card extractor tool 1000. In such a case, the motion limiting arm 1064 may include a first portion formed with a groove and a second portion formed with a tongue. The first portion may further be formed with a slot laterally there through and the second portion may be formed with an internally threaded hole. Similar to the daughter card engagement assembly 1014, an externally threaded thumb screw may be installed through the slot in the first portion of the motion limiting arm and the thumb screw may engage the internally threaded hole. The thumb screw 1034 may be loosened to allow relative motion between the second portion of the motion limiting arm 1064 and the first portion of the motion limiting arm 1064. Further, the thumb screw 1034 may be substantially tightened to prevent relative motion between the second portion of the motion limiting arm 1064 and the first portion of the motion limiting arm 1064. Accordingly, a length of the motion limiting arm 1064 may be changed.

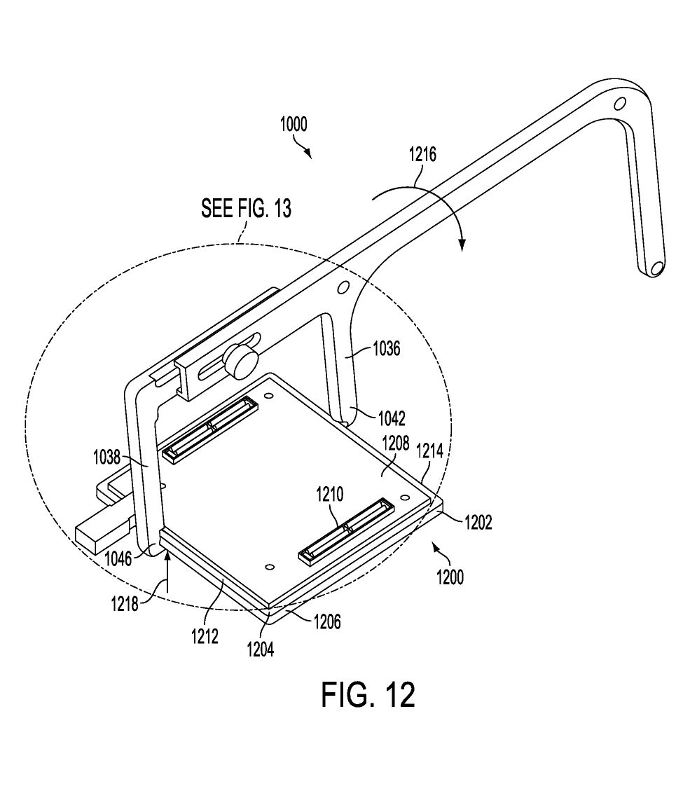

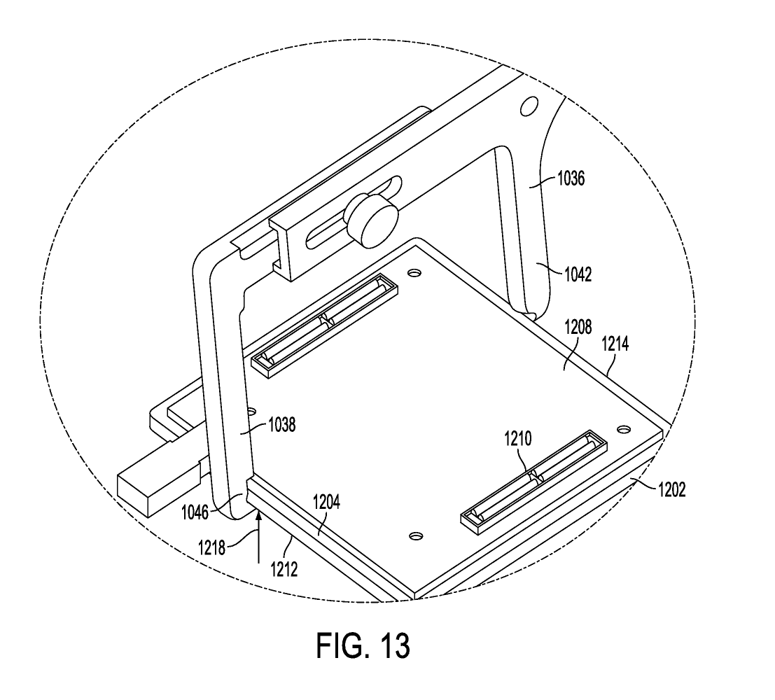

FIG. 11 is a cross-section view of the daughter card extractor tool 1000 taken along line 11-11 in FIG. 10. FIG. 12 is a view of the daughter card extractor tool 1000 as it is fully engaged with a daughter card 1200. FIG. 13 is a detailed view of the daughter card extractor tool 1000 as it is fully engaged with a daughter card 1200 taken at ellipse 13 in FIG. 12.

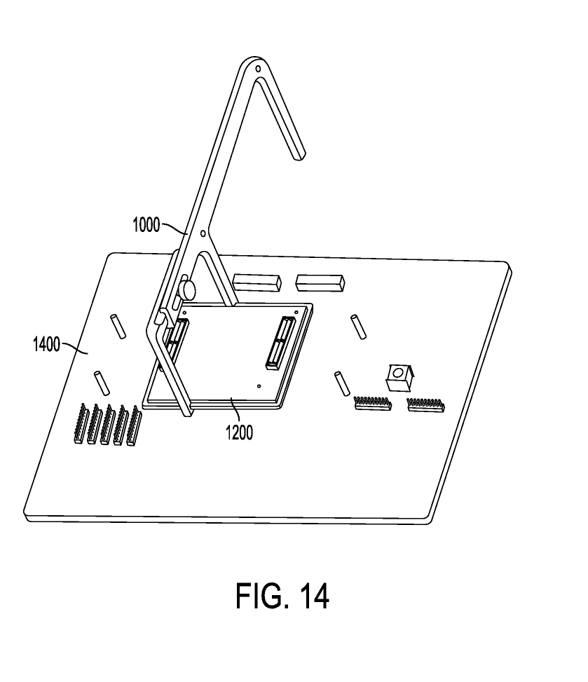

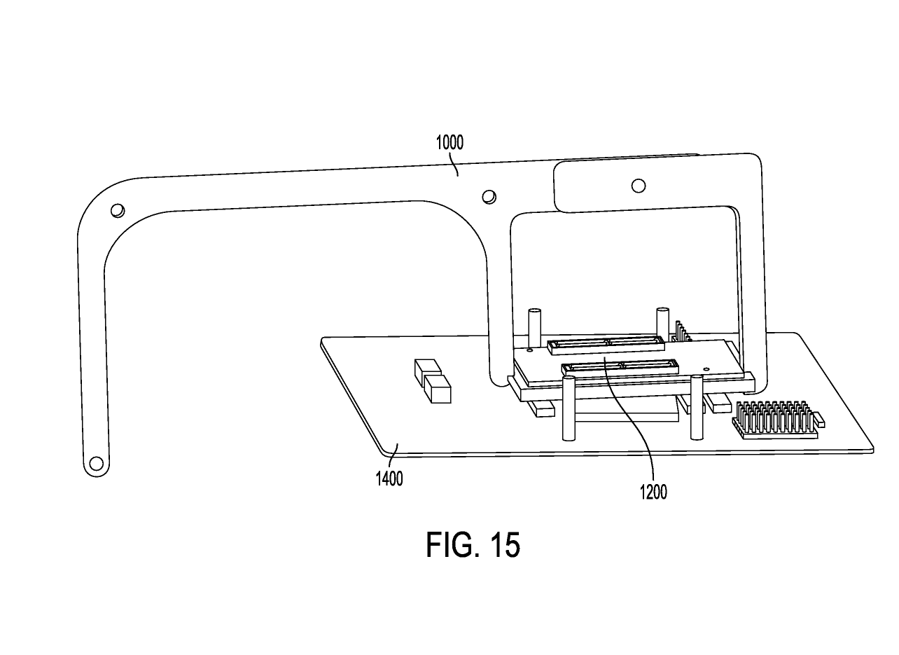

Referring now to FIG. 12 through FIG. 15, the daughter card extractor tool 1000 is engaged with a daughter card 1200. As shown, the daughter card 1200 includes a substrate 1202, or substrate. The substrate 1202 may include an upper surface 1204 and a lower surface 1206. A circuit board 1208 may be disposed on, or over, the upper surface 1204 of the substrate 1202. The daughter card 1200 may include at least one connector bank 1210 that may extend beyond the lower surface 1206 of the substrate 1202. In a particular aspect, the daughter card 1200 may include as many as five or six connector banks 1210. Each connector bank 1210 may be a one hundred twenty pin connector bank. The connector bank 1210 on the daughter card 1200 is sized and shaped to fit into, or around, a correspondingly sized and shaped connector bank (not shown) on a motherboard 1400, shown in FIG. 14 and FIG. 15. FIG. 12 indicates that the daughter card 1200 may define a leading edge 1212 and a trailing edge 1214.

During use of the daughter card extractor tool 1000, the hook 1050 formed in the distal end 1046 of the second daughter card engagement arm 1038 may be moved over the leading edge 1208 of the daughter card 1200 such that the upper face 1056 of the hook 1038 rests on, or otherwise engages, the upper surface 1204 of the substrate 1202 of the daughter card 1200. Thereafter, the daughter card extractor tool 1000 may be rotated clockwise in as shown in FIG. 12 and FIG. 15, as indicated by arc 1216, so that the notch 1048 formed in the distal end 1042 of the first daughter card engagement arm 1036 moves downward toward the upper surface 1204 of the substrate 1202 until the upper face 1052 of the notch 1048 rests against, or otherwise engages, the upper surface 1204 of the substrate 1202, as shown in FIG. 12 through FIG. 14.

As the daughter card extractor tool 1000 continues to rotate in the direction indicated by arc 1216, the upper face 1056 of the hook 1050 formed in the distal end 1046 of the second daughter card engagement arm 1038 may disengage from the upper surface 1204 of the substrate 1202 and the lower face 1060 of the hook 1050 formed in the distal end 1046 of the second daughter card engagement arm 1038 may engage the lower surface 1206 of the substrate 1202. The upper face 1052 of the notch 1048 formed in the distal end 1042 of the first daughter card engagement arm 1036 may remain in contact with the upper surface 1204 of the substrate 1202.

Further, the interface between the upper face 1052 of the notch 1048 and the area of contact on the upper surface 1204 of the substrate 1202 may act as a fulcrum and the daughter card extractor tool 1000 may rotate about the fulcrum. As the daughter card extractor tool 1000 continues to rotate in the direction indicated by arc 1216, the lower face 1060 of the hook 1050 may provide an extraction force 1218 on the lower surface 1206 of the substrate 1202. Once the extraction force 1218 overcomes the engagement force between the connector bank 1210 on the daughter card 1200 and the connector bank on the motherboard 1400, the daughter card 1200 may begin to disengage from the motherboard 1400. Once the daughter card 1200 is sufficiently disengaged from the motherboard 1400, a user may reach in with his or her thumb and forefinger to safely remove and retrieve the daughter card 1200 from the motherboard 1400.

With the configuration of structure described herein, each daughter card extractor tool 100, 1000 may be used to disengage a daughter card from a motherboard. The daughter card extractor tool 100, 1000 provides an appropriate force to disengage the daughter card from a motherboard while substantially minimizing the risk of damage to the daughter card, the motherboard, or a combination thereof. Further, each daughter card extractor tool 100, 1000 may be made from a non-metallic, non-conductive material, e.g., a polymer, in order to further minimize the risk of damage to the daughter card and the motherboard. Alternatively, each daughter card extractor tool 100, 1000 may be made have a metallic core that is coated or otherwise, surrounded by a non-metallic, non-conductive material. Further, the thickness of each daughter card extractor tool may be selected so as to further minimize the risk of damage to the daughter card, the motherboard, and other components within the motherboard. In particular, each daughter card extractor tool 100, 1000 may have a thickness that is less than or equal to one-quarter of an inch (0.25″).

Although selected aspects have been illustrated and described in detail, it will be understood that various substitutions and alterations may be made therein without departing from the spirit and scope of the present invention, as defined by the following claims. Further, elements from each aspect described herein may be combined to create additional aspects of daughter card extractor tools.

What is claimed is:

1. A daughter card extractor tool, comprising:
a handle defining a proximal end and a distal end; and
a daughter card engagement assembly extending from the distal end of the handle, wherein the daughter card extractor tool is movable between a first position in which the daughter card engagement assembly is partially engaged with a daughter card and the daughter card is engaged with a motherboard, a second position in which the daughter card engagement assembly is fully engaged with the daughter card and the daughter card remains engaged with the motherboard, and a third position in which the daughter card engagement assembly remains fully engaged with the daughter card and the daughter card is at least partially disengaged from the motherboard.

2. The daughter card extractor tool of claim 1, wherein the daughter card engagement assembly comprises a lateral arm extending from the distal end of the handle, the lateral arm defining a proximal end and a distal end.

3. The daughter card extractor tool of claim 2, wherein the lateral arm extends from the distal end of the handle at an angle with respect to the handle.

4. The daughter card extractor tool of claim 3, wherein the angle is in a range of one hundred ten degrees to one hundred thirty degrees (110°-130°).

5. The daughter card extractor tool of claim 3, wherein the daughter card engagement assembly further comprises a first daughter card extractor arm extending from the lateral arm and wherein the first daughter card extractor arm defines a proximal end and a distal end.

6. The daughter card extractor tool of claim 5, wherein the first daughter card extractor arm extends substantially perpendicular from the lateral arm.

7. The daughter card extractor tool of claim 5, wherein the daughter card engagement assembly further comprises a second daughter card extractor arm extending from the lateral arm and wherein the second daughter card extractor arm defines a proximal end and a distal end.

8. The daughter card extractor tool of claim 7, wherein the second daughter card extractor arm extends substantially perpendicular from the lateral arm in the same direction as the first daughter card extractor arm.

9. The daughter card extractor tool of claim 7, wherein the distal end of the first daughter card extractor arm is formed with a notch having an upper face and a side face extending perpendicularly from the upper face.

10. The daughter card extractor tool of claim 9, wherein the distal end of the second daughter card extractor arm is formed with a hook having an upper face, a side face extending perpendicularly from the upper face, and a lower face extending from the side face parallel to the upper face.

11. The daughter card extractor tool of claim 10, wherein the notch formed in the first daughter card extractor arm is configured to rest on a first edge of a daughter card.

12. The daughter card extractor tool of claim 11, wherein the hook formed in the second daughter card extractor arm is configured to fit over a second edge of the daughter card opposite the first edge of the daughter card.

13. The daughter card extractor tool of claim 12, wherein in the first position, the upper face of the notch contacts an upper surface of the daughter card and the hook does not engage the daughter card.

14. The daughter card extractor tool of claim 13, wherein in the second position, the upper face of the notch remains in contact with the upper surface of the daughter card and the upper face of the hook contacts the upper surface of the daughter card.

15. The daughter card extractor tool of claim 14, wherein in the third position, the upper face of the notch remains in contact with the upper surface of the daughter card and the lower face of the hook contacts a lower surface of the daughter card.

16. The daughter card extractor tool of claim 15, wherein in the third position the upper face of the notch acts as a fulcrum around which the daughter card extractor tool rotates.

17. The daughter card extractor tool of claim 15, wherein in the third position, the lower face of the hook provides an extraction force on the lower surface of the daughter card.

18. The daughter card extractor tool of claim 7, wherein the daughter card engagement assembly is adjustable to allow a distance between the first daughter card extractor arm and the second daughter card extractor arm to be changed.

19. The daughter card extractor tool of claim 18, wherein the daughter card engagement assembly comprises a first portion and a second portion, wherein the first daughter card extractor arm extends from the first portion and the second daughter card extractor arm extends from the second portion.

20. The daughter card extractor tool of claim 19, wherein the first portion of the daughter card engagement assembly is slidably engaged with the second portion of the daughter card engagement assembly.

21. The daughter card extractor tool of claim 20, wherein the first portion of the daughter card engagement assembly is formed with a groove, wherein the second portion of the daughter card engagement assembly is formed with a tongue, and wherein the tongue fits into the groove.

22. The daughter card extractor tool of claim 21, wherein the daughter card engagement assembly further comprises a screw extending through a slot formed in the first portion of the daughter card engagement assembly and threadably engaged with a hole in the second portion of the daughter card engagement assembly.

23. The daughter card extractor tool of claim 22, wherein the screw is configured to be loosened to allow relative motion between the first portion of the daughter card engagement assembly and the second portion of the daughter card engagement assembly.

24. The daughter card extractor tool of claim 22, wherein the screw is configured to be tightened to prevent relative motion between the first portion of the daughter card engagement assembly and the second portion of the daughter card engagement assembly.

25. The daughter card extractor tool of claim 7, further comprising a motion limiting arm extending from the proximal end of the handle.

26. The daughter card extractor tool of claim 25, wherein the motion limiting arm allows the daughter card extractor tool to move in range of first value to a second value.

27. The daughter card extractor tool of claim 25, wherein the first value is zero degrees (0°) and the second value is minus five degrees (−5.0°).

28. The daughter card extractor tool of claim 26, wherein the motion limiting arm allows the daughter card extractor tool to move in range of a first value to a second value.

29. The daughter card extractor tool of claim 25, wherein the motion limiting arm is adjustable to allow a length of the motion limiting arm to be changed.

30. The daughter card extractor tool of claim 29, wherein the motion limiting arm comprises a first portion and a second portion and wherein the first portion of the motion limiting arm is slidably engaged with the second portion of the motion limiting arm.

31. The daughter card extractor tool of claim 30, wherein the first portion of the motion limiting arm is formed with a groove, wherein the second portion of the motion limiting arm is formed with a tongue, and wherein the tongue fits into the groove.

32. The daughter card extractor tool of claim 31, wherein the motion limiting arm further comprises a screw extending through a slot formed in the first portion of the motion limiting arm and threadably engaged with a hole in the second portion of the motion limiting arm.

33. The daughter card extractor tool of claim 32, wherein the screw is configured to be loosened to allow relative motion between the first portion of the motion limiting arm and the second portion of the motion limiting arm.

34. The daughter card extractor tool of claim 32, wherein the screw is configured to be tightened to prevent relative motion between the first portion of the motion limiting arm and the second portion of the motion limiting arm.

35. A kit, comprising:
an electronic device having a motherboard;
a daughter card configured to be installed within the motherboard; and
a daughter card extractor tool configured to engage the daughter card when
the daughter card is installed in the motherboard and to provide an extraction force on a lower surface of the daughter card to disengage the daughter card from the motherboard.

36. A kit, comprising:
a daughter card configured to be installed within a motherboard; and
a daughter card extractor tool configured to engage the daughter card when the daughter card is installed in the motherboard and to provide an extraction force on a lower surface of the daughter card to disengage the daughter card from the motherboard.

37. A daughter card extractor tool, comprising:
a handle means; and
a daughter card engagement means extending from the handle means, wherein the daughter card extractor tool is movable between a first position in which the daughter card engagement means is partially engaged with a daughter card and the daughter card is engaged with a motherboard, a second position in which the daughter card engagement means is fully engaged with the daughter card and the daughter card remains engaged with the motherboard, and a third position in which the daughter card engagement means remains fully engaged with the daughter card and the daughter card is at least partially disengaged from the motherboard.

38. The daughter card extractor tool of claim 37, wherein the daughter card engagement means further comprises a first daughter card extractor means extending therefrom.

39. The daughter card extractor tool of claim 38, wherein the daughter card engagement means further comprises a second daughter card extractor means extending therefrom.

40. The daughter card extractor tool of claim 39, wherein the daughter card engagement means further comprises and adjustor means adjustable to allow a distance between the first daughter card extractor means and the second daughter card extractor means to be changed.

41. The daughter card extractor tool of claim 40, further comprising a screw means configured to be loosened to allow the daughter card engagement means to be adjusted and configured to be tightened to prevent relative motion within the daughter card engagement means.

42. The daughter card extractor tool of claim 37, further comprising a motion limiting means configured to allow the daughter card extractor tool to move in range of zero degrees (0°) to minus five degrees (−5.0°).

43. A method of extracting a daughter card from a mother board within an electronic device, the method comprising:
engaging a daughter card extractor tool with the daughter card;
moving the daughter card extractor tool from a first position in which a daughter card engagement assembly is partially engaged with the daughter card and the daughter card is engaged with a motherboard to a second position in which the daughter card engagement assembly is fully engaged with the daughter card and the daughter card remains engaged with the motherboard; and
moving the daughter card extractor tool from the second position to a third position in which the daughter card engagement assembly remains fully engaged with the daughter card and the daughter card is at least partially disengaged from the motherboard.

44. The method of claim 43, further comprising:
completely disengaging the daughter card from the motherboard.

45. The method of claim 44, further comprising:
removing the daughter card from the electronic device.

46. The method of claim 43, wherein in the first position, an upper face of a notch formed in the daughter card extractor tool contacts an upper surface of the daughter card and a hook formed in the daughter card extractor tool opposite the notch does not engage the daughter card.

47. The method of claim 46, wherein in the second position, the upper face of the notch remains in contact with the upper surface of the daughter card and an upper face of the hook contacts the upper surface of the daughter card.

48. The method of claim 47, wherein in the third position, the upper face of the notch remains in contact with the upper surface of the daughter card and a lower face of the hook contacts a lower surface of the daughter card.

49. The method of claim 48, wherein in the third position the upper face of the notch acts as a fulcrum around which the daughter card extractor tool rotates.

50. The method of claim 48, wherein in the third position, the lower face of the hook provides an extraction force on the lower surface of the daughter card.
